(19) United States
(12) Patent Application Publication
(10) Pub. No.: US 2013/0298799 A1
(43) Pub. Date: Nov. 14, 2013

(54) BITUMINOUS COMPOSITION WITH REDUCED EMISSION OF HYDROGEN SULFIDE

(71) Applicants: Sunil Ashtekar, Bangalore (IN); Sathya Narayanan, Bangalore (IN)

(72) Inventors: Sunil Ashtekar, Bangalore (IN); Sathya Narayanan, Bangalore (IN)

(21) Appl. No.: 13/995,538

(22) PCT Filed: Dec. 19, 2011
(86) PCT No.: PCT/EP2011/073220

§ 371 Date: Jul. 31, 2013

(30) Foreign Application Priority Data
Dec. 21, 2010 (IN) PCT/IN2010/000838

(51) Int. Cl. C08L 95/00

(52) U.S. Cl. CPC C08L 95/00
USPC 106/275

(57) ABSTRACT

The present invention relates to a bituminous composition comprising from 20 wt % to 99.9 wt % of bitumen, from 0.01 wt % to 10 wt % of a maleimide compound and from 0.5 to 75 wt % of sulphur, by weight of the bituminous composition. The present invention also relates to an asphalt composition comprising said bituminous composition and filler and/or aggregate. The bituminous and asphalt compositions of the present invention exhibit significantly reduced H₂S emissions.

### FIELD OF THE INVENTION

The invention relates to a bituminous composition and asphalt compositions comprising said bituminous composition. The invention further relates to a process for the manufacture of a bituminous composition and a process for the manufacture of an asphalt composition.

### BACKGROUND OF THE INVENTION

In the road construction and road paving industry, it is a well-practiced procedure to coat aggregate material such as sand, gravel, crushed stone or mixtures thereof with hot fluid bitumen, spread the coated material as a uniform layer on a road bed or previously built road while it is still hot, and compact the uniform layer by rolling with heavy rollers to form a smooth surfaced road.

The combination of bitumen with aggregate material, such as sand, gravel, crushed stone or mixtures thereof, is also referred to as “asphalt”. Bitumen, also referred to as “asphalt binder”, is usually a liquid binder comprising asphaltenes, resins and solvents.

It is known in the art that sulphur can be mixed with bitumen for applications in the road construction and road paving industry. Sulphur-modified bitumen is formulated by replacing some of the bitumen in conventional binders by elemental sulphur.

One of the problems encountered when using sulphur in bitumen is the unwanted formation of hydrogen sulphide, resulting from dehydrogenation reactions between bitumen and sulphur at high temperatures.

Even low hydrogen sulphide emission from sulphur-comprising asphalt, meaning asphalt formulated using sulphur-modified bitumen wherein elemental sulphur has been used to replace part of the bitumen, presents an emission nuisance on road paving projects. This is due to the gradual hydrogen sulphide gas concentration increase to high levels in the air voids in the loose paving mixture during storage in silos and during truck delivery to the paving site. The “stored” gas is released when the air pockets in the mixture are opened up as the mixture is dumped from the delivery trucks or as the mixture is subjected to mechanical mixing.

In view of the substantial amounts of sulphur used, especially in sulphur-containing asphalt having high sulphur-bitumen weight ratios, e.g. as high as 1:1, hydrogen sulphide emission is a serious problem. Therefore, it is necessary to reduce the unwanted formation and emission of hydrogen sulphide from sulphur-comprising asphalt.

Various attempts have been made to reduce hydrogen sulphide emissions from sulphur-modified bitumen and asphalt compositions. However, further improvements are needed.

### SUMMARY OF THE INVENTION

It has now been found that significantly reduced hydrogen sulphide emissions can be achieved by incorporating selected maleimide compounds into bituminous and asphalt compositions comprising significant amounts of sulphur.

Hence according to the present invention there is provided a bituminous composition comprising from 20 wt % to 99.9 wt % of bitumen and from 0.01 wt % to 10 wt % of a maleimide compound and additionally comprising from 0.5 to 75 wt % of sulphur. All weight percentages herein are by weight of the bituminous composition unless otherwise specified.

According to another aspect of the present invention there is provided an asphalt composition comprising the bitumen composition as claimed herein and filler and/or aggregate.

According to another aspect of the present invention there is provided a process for manufacturing the bituminous composition according to the present invention, the process comprising the steps of:
(i) heating bitumen;
(ii) mixing the hot bitumen so obtained with an amount of sulphur in the range of from 0.5 wt % to 75 wt %;
   wherein from 0.01 wt % to 10 wt % of a maleimide compound is added in at least one of the steps (i) or (ii), all weight % being by weight of the bituminous composition.

According to yet another aspect of the present invention there is provided a process for manufacturing the asphalt composition according to the present invention, the process comprising the steps of:
(i) heating bitumen;
(ii) heating aggregate;
(iii) mixing the hot bitumen with the hot aggregate in a mixing unit to form an asphalt composition;
   wherein from 0.5 wt % to 75 wt % of sulphur, is added in at least one of steps (i), (ii) or (iii); and wherein from 0.01 wt % to 10 wt % of a maleimide compound, is added in at least one of the steps (i), (ii) or (iii), all weight % being by weight of the bituminous composition comprising bitumen, maleimide compound, and sulphur.

According to yet another aspect of the present invention there is provided the use of a maleimide compound for reducing hydrogen sulphide emissions from a bituminous composition wherein the bituminous composition comprises from 20 wt % to 99.9 wt % of bitumen and from 0.01 wt % to 10 wt % of a maleimide compound and additionally comprising from 0.5 to 75 wt % of sulphur, by weight of the bituminous composition.

### DETAILED DESCRIPTION OF THE INVENTION

A first essential component of the bituminous composition herein is bitumen. The bitumen can be selected from a wide range of bituminous compounds. Whereas some documents in the prior art prescribe that the bitumen must have been subjected to blowing before it is to be used in paving applications, such requirement is not needed in the compositions according to the present invention. So, bitumen that can be employed may be straight run bitumen, thermally cracked residue or precipitation bitumen, e.g., from propane. Although not necessary, the bitumen may also have be subjected to blowing. The blowing may be carried out by treating the bitumen with an oxygen-containing gas, such as air, oxygen-enriched air, pure oxygen or any other gas that comprises molecular oxygen and an inert gas, such carbon dioxide or nitrogen. The blowing operation may be conducted at temperatures of 175 to 400° C., preferably from 200 to 350° C. Alternatively, the blowing treatment may be conducted by means of a catalytic process. Suitable catalysts in such processes include ferric chloride, phosphoric acid, phosphorus pentoxide, aluminium chloride and boric acid. The use of phosphoric acid is preferred.

The bitumen for use herein is preferably a paving grade bitumen suitable for road application having a penetration of, for example, from 9 to 1000 dmm, more preferably of from 15 to 450 dmm (tested at 25° C. according to EN 1426: 1999) and a softening point of from 25 to 100° C., more preferably of from 25 to 60° C. (tested according to EN 1427: 1999).

The bitumen content in the bitumen composition according to the invention may range from 20 to 90% wt, based on the weight of the bituminous composition. Good results have been obtained with amounts ranging from 50 to 75% wt.

A second essential component of the bituminous composition herein is a maleimide compound.

The maleimide compound is present at a level in the range of from 0.01 wt % to 10 wt %, preferably in the range of 0.1 wt % to 5 wt %, more preferably in the range of 0.2 wt % to 3.5 wt %, all percentages being by weight of the bituminous composition.

The maleimide compound is preferably selected from compounds of formula I or formula II:

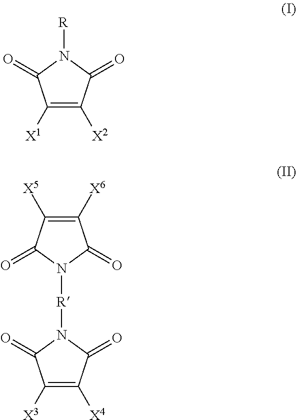

wherein R is H, alkyl, aryl or aralkyl; R′ is alkylene, arylene or aralkylene; and X¹, X², X³, X⁴, X⁵ and X⁶ are independently chosen from H and alkyl groups.

Alkyl, aryl or aralkyl groups may be heteroatom-substituted, e.g. alkyl-O-alkyl, alkyl-S-alkyl, aryl-β-aryl or aryl-S-aryl.

Alkylene, arylene or aralkylene groups may be heteroatom-substituted, e.g. alkylene-O-alkylene, alkylene-S-alkylene, arylene-O-arylene or arylene-S-arylene.

With reference to formula II, R′ is bivalent. An alkylene, arylene or aralkylene group is a bivalent alkyl, aryl or aralkyl group respectively. The group is bivalent as it connects to two maleimide groups.

Preferably X¹, X², X³, X⁴, X⁵ and X⁶ are H.

Preferably R is H, C₁₋₄ alkyl or phenyl. Most preferably R is H.

Preferably R′ is C₁₋₈ alkylene or is chosen from the groups shown below:

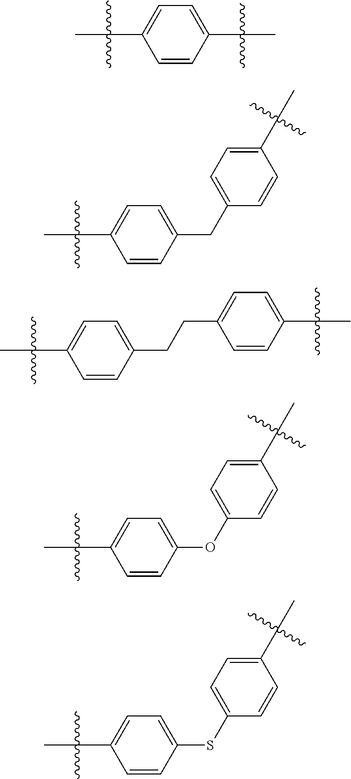 [SMILES: *c1ccc(*)cc1 ; *c1ccc(Cc2ccc(*)cc2)cc1 ; *c1ccc(CCc2ccc(*)cc2)cc1 ; *c1ccc(Oc2ccc(*)cc2)cc1 ; *c1ccc(Sc2ccc(*)cc2)cc1]

A preferred maleimide compound of formula (I) is maleimide. A preferred maleimide compound of formula (II) is N,N′-(4,4′-Diphenylmethane)bismaleimide.

Sulphur constitutes a part of the binder material herein. Preferably, substantial amounts of sulphur are used in the bituminous composition of the present invention as a binder, however smaller amounts of sulphur (e.g. 0.5-2 wt % where sulphur is used as a cross-linking agent) can also be employed. In the composition of the present invention the sulphur is present in amounts ranging from 0.5 to 75% wt, more preferably from 5 to 75% wt, based on the weight of the bituminous composition. Suitably, sulphur may be present in the bitumen composition in amounts ranging from 20 to 60% wt, since the strength enhancement that is being provided to the bitumen composition by the sulphur is reduced when less than 20% wt of sulphur is being used in the bitumen composition according to the invention.

As described in WO-A 03/014231 the sulphur may be added to the bitumen composition in the form of sulphur pellets, and preferably, the sulphur is incorporated into the compositions of the present invention in this form. Reference herein to pellets is to any type of sulphur material that has been cast from the molten state into some kind of regularly sized particle, for example flakes, slates or sphere-shaped sulphur such as prills, granules, nuggets and pastilles or half pea sized sulphur. The sulphur pellets typically comprise from 50 to 100 wt % of sulphur, based upon the weight of the sulphur pellets, preferably from 60 wt % and most preferably from 70 wt %; and typically to 99 wt %, and preferably to 95 wt % or to 100 wt %. A more preferred range is from 60 to 100 wt %.

These pellets may contain carbon black and, optionally, other ingredients, such as amyl acetate and wax. Carbon black may be present in amounts up to 5% wt, based on the pellet, preferably up to 2% wt. Suitably, the content of carbon black in the sulphur pellet is at least 0.25% wt. The content of other ingredients, such as amyl acetate and wax, typically does not exceed an amount of 1.0% wt each. When wax is present, it may be in the form of, for example, wax derived from a Fischer-Tropsch process. Examples of suitable waxes for use herein are Sasobit®, a Fischer-Tropsch derived wax commercially available from Sasol, and SX100 wax, a Fischer-Tropsch wax from Shell Malaysia.

In one embodiment of the present invention, the maleimide compound is present in the sulphur pellet.

An example of a suitable sulphur pellet for use herein is Thiopave® pellets commercially available from Shell Canada.

Whereas the bituminous composition according to the invention comprises the three essential components, bitumen, maleimide compound and sulphur, it is evident to the skilled person that to such a composition also different compounds may be added.

For instance, the bituminous composition herein may comprise one or more polymers. Suitable polymers for use herein include those disclosed in WO-A 03/014231 and copending European patent application 10305176.9. Examples of suitable polymers for use herein include, but are not limited to, styrene butadiene rubber and a styrene-butadiene-styrene block copolymer.

The bituminous composition according to the present invention may also comprise an odour suppressant.

The bituminous and asphalt compositions of the present invention may also comprise wax, for example, slack wax or wax derived from a Fischer-Tropsch process. Examples of suitable waxes for use herein are Sasobit®, a Fischer-Tropsch derived wax commercially available from Sasol, and SX100 wax, a Fischer-Tropsch wax from Shell Malaysia.

The bituminous and asphalt compositions of the present invention may also comprise Warm Mix Asphalt additives. Examples of suitable Warm Mix Asphalt additives include, but are not limited to, Evotherm 3G commercially available from MeadWestvaco and Rediset WMX commercially available from Akzo Nobel.

The bituminous and asphalt compositions of the present invention may also comprise anti-stripping agents.

The bituminous and asphalt compositions of the present invention may also comprise ethylene bisstearamide as disclosed in WO2009/121913.

The bitumen composition according to the invention is advantageously used in the form of an asphalt composition comprising the bitumen composition and filler and/or aggregate. Examples of fillers have been described in U.S. Pat. No. 5,863,971, and include carbon black, silica, calcium carbonate, stabilisers, antioxidants, pigments and solvents. Examples of aggregates include sand, rock, gravel, stones, pebbles etc. These aggregate materials are particularly useful for paving roads.

Typically, the asphalt composition comprises at least 1 wt % of bitumen, based on the weight of the asphalt composition. An asphalt composition comprising from about 1 weight % to about 10 weight % of bitumen is preferred, with a special preference for asphalt compositions comprising from about 3 weight % to about 7 weight % of bitumen, based on the weight of the asphalt composition.

The bituminous composition according to the present invention can be prepared by mixing bitumen, maleimide compound and sulphur in the appropriate amounts.

Accordingly, the present invention provides a process for manufacturing the bituminous composition according to the present invention, the process comprising the steps of:
(i) heating bitumen;
(ii) mixing the hot bitumen so obtained with an amount of sulphur in the range of from 0.5 wt % to 75 wt %;
   wherein from 0.01 wt % to 10 wt % of a maleimide compound is added in at least one of the steps (i) or (ii), all weight % being by weight of the bituminous composition.

According to another aspect of the present invention there is provided a process for manufacturing a bituminous composition comprising the steps of:
(i) heating a preblend of bitumen and maleimide compound wherein the level of maleimide compound is in the range of from 0.01 wt % to 10 wt %, by weight of the bituminous composition;
(ii) mixing the heated preblend of bitumen and maleimide compound with an amount of sulphur in the range of from 0.5 wt % to 75 wt %, by weight of the bituminous composition.

The present invention also provides a process for manufacturing the asphalt composition according to the present invention, the process comprising the steps of:
(i) heating bitumen;
(ii) heating aggregate;
(iii) mixing the hot bitumen with the hot aggregate in a mixing unit to form an asphalt composition;
   wherein from 0.5 wt % to 75 wt % of sulphur, is added in at least one of steps (i), (ii) or (iii); and wherein from 0.01 wt % to 10 wt % of maleimide compound, is added in at least one of the steps (i), (ii) or (iii), all weight % being by weight of the bituminous composition comprising bitumen, maleimide compound, and sulphur.

The present invention also provides a process for manufacturing the asphalt composition according to the present invention, the process comprising the steps of:
(i) heating a preblend of bitumen and maleimide compound wherein the level of maleimide compound is in the range of from 0.01 wt % to 10 wt %;
(ii) heating aggregate;
(iii) mixing the hot preblend of bitumen and maleimide compound with the hot aggregate in a mixing unit to form an asphalt composition; wherein from 0.5 wt % to 75 wt % of sulphur, is added in at least one of steps (i), (ii) or (iii); all weight % being by weight of the bituminous composition.

In step (i) of the processes for manufacturing the present bituminous or asphalt compositions the bitumen (or preblend of bitumen and maleimide compound) is heated, preferably at a temperature of from 60° C. to 200° C., preferably from 80 to 150° C., more preferably from 100° C. to 145° C., and even more preferably from 125° C. to 145° C. Working above 120° C. has the advantage that sulphur is liquid which facilitates the mixing process. Although the skilled person can easily determine the optimal mixing time, the mixing time may be relatively short, e.g., from 10 to 600 seconds.

In step (ii) of the process for manufacturing the present asphalt composition the aggregate is heated, preferably at a temperature of from 60 to 200° C., preferably from 80 to 170° C., more preferably from 100 to 160° C., even more preferably from 100 to 145° C. The aggregate is suitably any aggregate that is suitable for road applications. The aggregate may consist of a mixture of coarse aggregate (retained on a 4 mm sieve), fine aggregate (passes a 4 mm sieve but is retained on a 63 μm sieve) and filler (passes a 63 μm sieve).

In step (iii) of the asphalt manufacturing process, the hot bitumen (or hot preblend of bitumen and maleimide compound) and hot aggregate are mixed in a mixing unit. Suitably, the mixing takes place at a temperature of from 80 to 200° C., preferably from 90 to 150° C., more preferably from 100 to 145° C. Typically, the mixing time is from 10 to 60 seconds, preferably from 20 to 40 seconds.

The temperatures at which the bitumen and aggregate are heated and subsequently mixed are desirably kept as low as possible in order to reduce hydrogen sulphide emissions when the sulphur is added. However, the temperatures need to be sufficiently high such that the bitumen can effectively coat the aggregate. The present invention allows for bitumen, aggregate and sulphur mixes to be produced with suppression of H₂S emanating from the asphalt mixture.

In the process of manufacturing asphalt, sulphur is preferably added as late as possible in the process, preferably in step (iii).

In the processes of the present invention, it is preferable to add sulphur in the form of sulphur pellets, as described above.

The sulphur and the maleimide compound may be added together, i.e. both in step (i), step (ii) or step (iii) of the respective processes for manufacturing the present bituminous and asphalt compositions. In a first embodiment, the hot aggregate is mixed with the sulphur and the maleimide compound. Hot bitumen is then added to the hot aggregate-sulphur-maleimide compound mixture. In a second embodiment, hot aggregate is mixed with hot bitumen, and the sulphur and the maleimide compound are added to the hot bitumen-aggregate mixture. This embodiment offers the advantage of producing a stronger sulphur-asphalt mixture strength. In a third embodiment, hot bitumen is mixed with sulphur and the maleimide compound and the resulting hot bitumen-sulphur-maleimide compound mixture is mixed with hot aggregate to obtain a sulphur-comprising asphalt mixture.

Alternatively, in the asphalt manufacture process the maleimide compound may be added separately. For example, the maleimide compound may be added to the bitumen in step (i) and the sulphur may be added in step (iii).

In one embodiment of the invention, the sulphur and the maleimide compound are added together; the sulphur is in the form of pellets and the maleimide compound is incorporated in the sulphur pellets. The sulphur pellets preferably comprise from 0.01 to 20 wt %, preferably from 0.01 to 10% by weight, more preferably from 1 to 5% by weight of the maleimide compound, based upon the weight of the sulphur pellet. The sulphur pellets are suitably prepared by a process wherein liquid sulphur is mixed with the maleimide compound and optionally additional components such as carbon black, amyl acetate and any suitable emulsifying agent. The mixture is then shaped and/or pelletised.

In one embodiment of the invention sulphur may be added in the form of two types of sulphur pellets; a first type of sulphur pellet that comprises the maleimide compound and a second type of sulphur pellet that does not comprise the maleimide compound. This has the advantage that the maleimide compound is essentially concentrated in the first type of sulphur pellet and conventional sulphur pellets can be used to make up the rest of the sulphur requirement.

The invention further provides a process for preparing an asphalt pavement, wherein asphalt is prepared by a process according to the invention, and further comprising steps of:
(iv) spreading the asphalt into a layer; and
(v) compacting the layer.

The invention further provides an asphalt pavement prepared by the processes according to the invention.

The compaction in step (v) suitably takes place at a temperature of from 80 to 200° C., preferably from 90 to 150° C., more preferably from 100 to 145° C. The temperature of compaction is desirably kept as low as possible in order to reduce hydrogen sulphide emissions. However, the temperature of compaction needs to be sufficiently high such that the voids content of the resulting asphalt is sufficiently low for the asphalt to be durable and water resistant.

The invention will now be described by reference to examples which are illustrated by means of the following Examples, which are not intended to limit the invention.

### EXAMPLES

16.2 g of elemental sulphur pellets (containing 99 wt % sulphur and 1 wt % carbon black) were placed in a 500 ml round bottom flask (RBF) and melted at 140° C. using a hot plate stirrer. After complete melting of the sulphur pellets, 24.4 g of bitumen was added into the flask. 0.77 g of N,N′-(4,4′-Diphenylmethane)bismaleimide was added after addition of bitumen into the flask at 140° C. The contents were stirred at 1000 rpm for a period of 4 min at 140° C. After 4 min of heating and mixing, the stirring rate was reduced to 275 rpm and a Dräger tube was connected to one neck of the 3-necked flask. After 10 seconds of mixing at 275 rpm, a Dräger “Multiwarn” electronic gas meter was connected to the tube and H₂S emissions were recorded. The results are shown in Table 1 below.

TABLE 1

| | Maleimide Compound | H₂S (ppm) |
|---|---|---|
| Comparative | None | 39 |
| Example 1 | | |
| Example 1 | 0.77 g N,N′-(4,4′- | 10 |
| | Diphenylmethane)bismaleimide | |

The results show that addition of the maleimide compound led to a significant reduction in hydrogen sulphide emission.

1. A bituminous composition, comprising from 20 wt % to 99.9 wt % of bitumen; from 0.01 wt % to 10 wt % of a maleimide compound; and from 0.5 to 75 wt % of sulphur, by weight of the bituminous composition.

2. A composition according to claim 1, wherein the maleimide compound is selected from compounds of formula I or formula II: 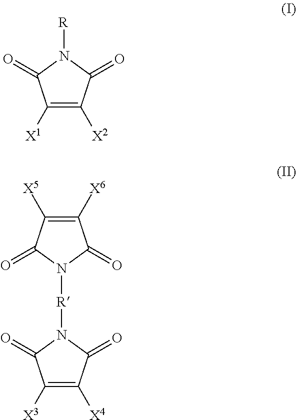
wherein R is H, alkyl, aryl or aralkyl; R′ is alkylene, arylene or aralkylene; and X¹, X², X³, X⁴, X⁵ and X⁶ are independently chosen from H and alkyl groups.

3. A composition according to claim 2, wherein the maleimide compound is of formula (I), X¹ and X² are H, and R is H, C₁₋₄ alkyl or phenyl.

4. A composition according to claim 2, wherein the maleimide is of formula (II), X³, X⁴, X⁵ and X⁶ are H, and R′ is C₁₋₈ alkylene or is chosen from the groups shown below:

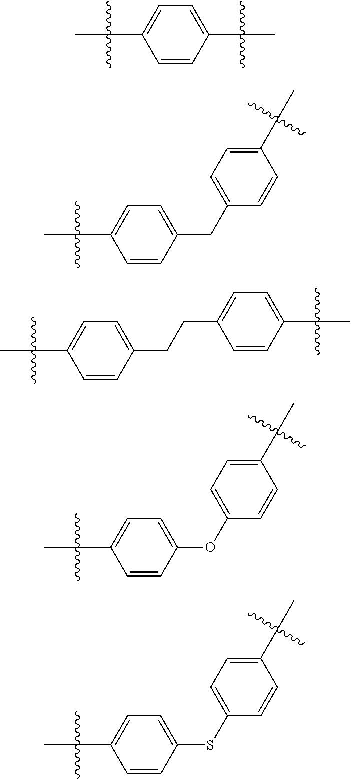 [SMILES: *c1ccc(*)cc1 ; *c1ccc(Cc2ccc(*)cc2)cc1 ; *c1ccc(CCc2ccc(*)cc2)cc1 ; *c1ccc(Oc2ccc(*)cc2)cc1 ; *c1ccc(Sc2ccc(*)cc2)cc1]

5. An asphalt composition, comprising: the bitumen composition as claimed in claim 1 and filler and/or aggregate.

6. A process for manufacturing the bituminous composition as claimed in claim 1, the process comprising the steps of:
(i) heating bitumen;
(ii) mixing the hot bitumen so obtained with an amount of sulphur in the range of from 0.5 wt % to 75 wt %;
wherein from 0.01 wt % to 10 wt % of a maleimide compound is added in at least one of the steps (i) or (ii), all weight % being by weight of the bituminous composition.

7. A process for manufacturing the asphalt composition as claimed in claim 5, the process comprising the steps of:
(i) heating bitumen;
(ii) heating aggregate;
(iii) mixing the hot bitumen with the hot aggregate in a mixing unit to form an asphalt composition;
wherein from 0.5 wt % to 75 wt % of sulphur, is added in at least one of steps (i), (ii) or (iii); and wherein from 0.01 wt % to 10 wt % of a maleimide compound, is added in at least one of the steps (i), (ii) or (iii), all weight % being by weight of the bituminous composition comprising bitumen, maleimide compound, and sulphur.

8. A method of reducing hydrogen sulphide emissions from a bituminous composition, wherein the bituminous composition comprises from 20 wt % to 99.9 wt % of bitumen, and from 0.5 to 75 wt % of sulphur, by weight of the bituminous composition, by incorporation from 0.01 wt % to 10 wt % of a maleimide compound into the bituminous composition.

9. An asphalt composition, comprising: the bitumen composition as claimed in claim 2 and filler and/or aggregate.

10. An asphalt composition, comprising: the bitumen composition as claimed in claim 3 and filler and/or aggregate.

11. An asphalt composition, comprising: the bitumen composition as claimed in claim 4 and filler and/or aggregate.

12. A process as recited in claim 6, wherein the maleimide compound is selected from compounds of formula I or formula II:

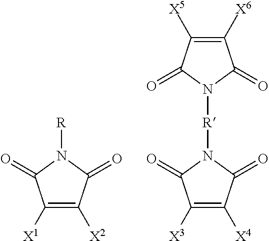

13. A process as recited in claim 12, wherein the maleimide compound is of formula (I), X¹ and X² are H, and R is H, C₁₋₄ alkyl or phenyl.

14. A process as recited in claim 13, wherein the maleimide is of formula (II), X³, X⁴, X⁵ and X⁶ are H, and R′ is C₁₋₈ alkylene or is chosen from the groups shown below:

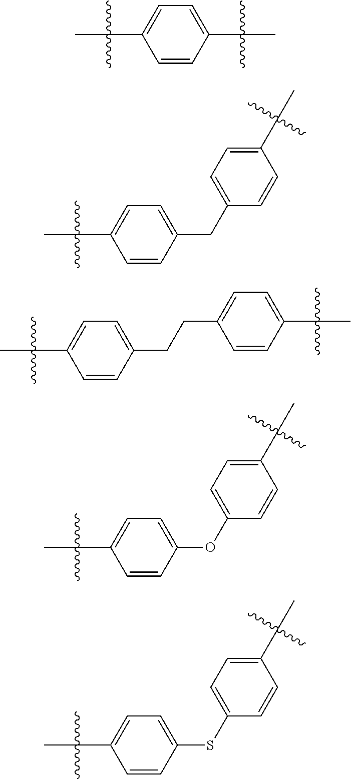 [SMILES: *c1ccc(*)cc1 ; *c1ccc(Cc2ccc(*)cc2)cc1 ; *c1ccc(CCc2ccc(*)cc2)cc1 ; *c1ccc(Oc2ccc(*)cc2)cc1 ; *c1ccc(Sc2ccc(*)cc2)cc1]

15. A process as recited in claim 7, wherein the maleimide compound is of formula (I), X¹ and X² are H, and R is H, C₁₋₄ alkyl or phenyl.

16. A process as recited in claim 15, wherein the maleimide is of formula (II), X³, X⁴, X⁵ and X⁶ are H, and R′ is C₁₋₈ alkylene or is chosen from the groups shown below:

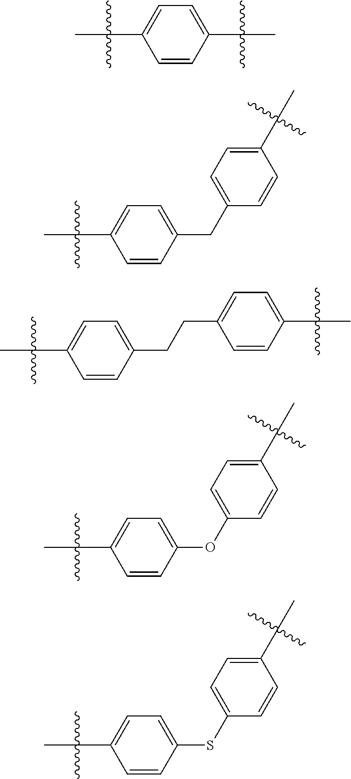 [SMILES: *c1ccc(*)cc1 ; *c1ccc(Cc2ccc(*)cc2)cc1 ; *c1ccc(CCc2ccc(*)cc2)cc1 ; *c1ccc(Oc2ccc(*)cc2)cc1 ; *c1ccc(Sc2ccc(*)cc2)cc1]

17. A method of reducing hydrogen sulphide emissions from a bituminous composition, wherein the maleimide compound is of formula (I), X¹ and X² are H, and R is H, C₁₋₄ alkyl or phenyl.

18. A method of reducing hydrogen sulphide emissions from a bituminous composition, wherein the maleimide is of formula (II), X³, X⁴, X⁵ and X⁶ are H, and R′ is C₁₋₈ alkylene or is chosen from the groups shown below: 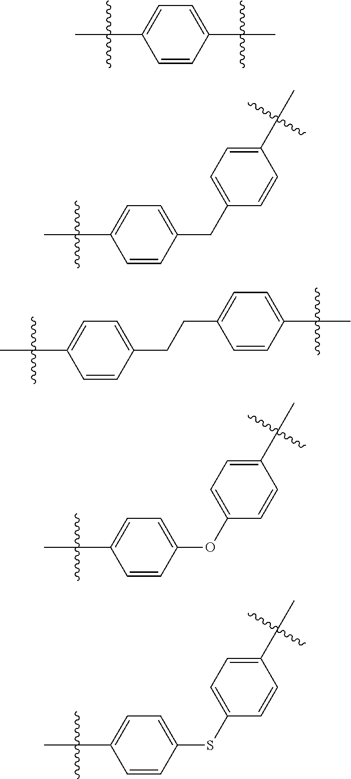 [SMILES: *c1ccc(*)cc1 ; *c1ccc(Cc2ccc(*)cc2)cc1 ; *c1ccc(CCc2ccc(*)cc2)cc1 ; *c1ccc(Oc2ccc(*)cc2)cc1 ; *c1ccc(Sc2ccc(*)cc2)cc1]
